(19) United States
(12) Patent Application Publication
(10) Pub. No.: US 2006/0220583 A1
(43) Pub. Date: Oct. 5, 2006

(54) GREEN SHEET, PLASMA DISPLAY PANEL AND METHOD OF MANUFACTURING PLASMA DISPLAY PANEL

(75) Inventor: Jeseok KIM, Anyang-si, Gyeonggi-do (KR)

Correspondence Address: FISH & RICHARDSON P.C., P.O. BOX 1022, MINNEAPOLIS, MN, 55440-1022, US

(73) Assignee: Leader Electronics Corporation, Seoul (KR)

(21) Appl. No.: 11/277,712

(22) Filed: Mar. 28, 2006

(30) Foreign Application Priority Data
Mar. 29, 2005 (KR) 10-2005-0026144
Mar. 29, 2005 (KR) 10-2005-0026147
Mar. 29, 2005 (KR) 10-2005-0026162

(51) Int. Cl. G09G 3/10

(52) U.S. Cl. 315/169.4

(57) ABSTRACT

A green sheet, a plasma display panel using the green sheet and a method of manufacturing a plasma display panel are provided. The method of manufacturing the plasma display panel comprises laminating a green sheet comprising a dielectric layer and an electrode pattern on a substrate, and firing the substrate. The plasma display panel comprises a substrate, a black layer formed on the substrate, an electrode formed on the black layer, and a dielectric layer formed on the electrode, the black layer and an upper surface of the substrate. Further, there is a difference in elevation among the dielectric layer on the electrode, the dielectric layer on the black layer and the dielectric layer on the upper surface of the substrate. The green sheet comprises a dielectric layer, and a conductive layer formed on the dielectric layer.

This Nonprovisional application claims priority under 35 U.S.C. § 119(a) on Patent Application Nos. 10-2005-0026144, 10-2005-0026147 and 10-2005-0026162 and filed in Korea on Mar. 29, 2005 the entire contents of which are hereby incorporated by reference.

### BACKGROUND OF THE INVENTION

1. Field of the Invention

This document relates to a plasma display panel, and more particularly to a plasma display panel and a green sheet capable of simplifying a manufacturing method and reducing the manufacturing cost.

2. Description of the Background Art

A plasma display panel generally comprises a front panel and a rear panel. Barrier ribs formed between the front panel and the rear panel form discharge cells. Each of the discharge cells is filled with an inert gas containing a main discharge gas such as neon (Ne), helium (He) or a Ne—He gas mixture and a small amount of xenon (Xe). When a high frequency voltage generates a discharge of the inert gas, the discharge of the inert gas emits vacuum ultraviolet rays. A phosphor formed between the barrier ribs emits visible light by vacuum ultraviolet rays_to display an image on the plasma display panel. Since the plasma display panel can be manufactured to be thin and light, the plasma display panel has been considered as a next generation display apparatus.

FIG. 1 is a schematic perspective view of a structure of a related art plasma display panel. As shown in FIG. 1, the plasma display panel comprises a front panel 100 and a rear panel 110 which are coupled in parallel to be opposed to each other at a given distance therebetween. The front panel 100 comprises a front glass substrate 101 being a display surface on which an image is displayed, and the rear panel 110 comprises a rear glass substrate 111 being a rear surface. A plurality of scan electrodes 102 and a plurality of sustain electrodes 103 are formed in pairs on the front glass substrate 101 to form a plurality of maintenance electrode pairs. A plurality of address electrodes 113 are formed on the rear glass substrate 111 to intersect the plurality of maintenance electrode pairs.

The scan electrode 102 and the sustain electrode 103 each comprise transparent electrodes 102a and 103a made of a transparent indium-tin-oxide (ITO) material and bus electrodes 102b and 103b made of a metal material. The scan electrode 102 and the sustain electrode 103 generate a mutual discharge therebetween in one discharge cell and maintain light-emissions of the discharge cells. Since the metal material such as Ag forming the bus electrodes 102b and 103b does not transmit light generated by the discharge and reflects light generated from the outside of the plasma display panel, the contrast is degraded. In order to solve the above-described problem, a black layer (not shown) capable of improving the contrast is formed between the transparent electrodes 102a and 103a and the bus electrodes 102b and 103b. The scan electrode 102 and the sustain electrode 103 are covered with one or more upper dielectric layers 104 for limiting a discharge current and providing insulation between the maintenance electrode pairs. A protective layer 105 with a deposit of MgO is formed on an upper surface of the upper dielectric layer 104 to facilitate discharge conditions.

A plurality of stripe-type (or well-type) barrier ribs 112 are formed in parallel on the rear panel 110 to form a plurality of discharge spaces, that is, a plurality of discharge cells. The plurality of address electrodes 113 are arranged in parallel with the barrier ribs 112 to perform an address discharge and generate vacuum ultraviolet rays. Red (R), green (G) and blue (B) phosphors 114 are coated on an upper surface of the rear panel 110 to emit visible light for the display of an image during the generation of the address discharge. A lower dielectric layer 115 is formed between the address electrodes 113 and the phosphors 114 to protect the address electrodes 113.

After completing a process for manufacturing the above-described front panel and a process for manufacturing the above-described rear panel, a sealing process for coalescing the front panel and the rear panel is performed to complete the plasma display panel. The process for manufacturing the front panel and the process for manufacturing the rear panel are described in detail with reference to FIG. 2.

FIG. 2 illustrates a method of manufacturing a related art plasma display panel. As shown in FIG. 2, a method of manufacturing the related art plasma display panel comprises a process for manufacturing a front panel shown in the left side of FIG. 2, a process for manufacturing a rear panel shown in the right side of FIG. 2, and an assembling process of the front panel and the rear panel shown in the lower side of FIG. 2.

First, the process of manufacturing the front panel shown in the left side of FIG. 2 is described. Front glass is prepared in step 200, and then a plurality of maintenance electrode pairs are formed on an upper part of the front glass in step 210. Afterwards, an upper dielectric layer is formed on the maintenance electrode pairs in step 220 and a protective layer made of MgO for protecting the sustain electrode pairs is formed on the upper dielectric layer in step 230.

Next, the process of manufacturing the rear panel shown in the right side of FIG. 2 is described. In the same way as the process of manufacturing the front panel, first, rear glass is prepared in step 240, and then a plurality of address electrodes are formed on the rear glass to intersect the maintenance electrode pairs formed on the front panel in step 250. Afterwards, a lower dielectric layer is formed to cover the address electrode in step 260. Barrier ribs are formed on an upper surface of the lower dielectric layer in step 270. A phosphor layer is formed on a discharge space between the barrier ribs in step 280.

The front panel and the rear panel thus manufactured are coalesced with each other in step 290 to complete the plasma display panel in step 300.

However, as described above, since a printing step, a drying step and an exposure step are performed repeatedly in the manufacturing process of the front panel of the plasma display panel, the time required for the manufacturing process of the front panel is longer. As a result, the manufacturing yield decreases and the manufacturing cost increases.

### SUMMARY OF THE INVENTION

Accordingly, an object of the present invention is to solve at least the problems and disadvantages of the background art.

The present invention provides a method of manufacturing a plasma display panel capable of simplifying a manufacturing process and reducing the manufacturing cost by forming a bus electrode and a dielectric layer by the lamination of a green sheet on a front panel.

The present invention also provides a plasma display panel capable of reducing a discharge voltage and increasing the efficiency of the plasma display panel since there is a difference in elevation among dielectric layers formed on an electrode, a black layer and a front panel.

The present invention also provides a green sheet comprising a dielectric layer and a conductive layer.

The present invention also provides a green sheet comprising a dielectric layer and an electrode pattern layer.

The present invention also provides a method of manufacturing a green sheet comprising a dielectric layer and a conductive layer.

The present invention also provides a method of manufacturing a green sheet comprising a dielectric layer and an electrode pattern layer.

### BRIEF DESCRIPTION OF THE DRAWINGS

The invention will be described in detail with reference to the following drawings in which like numerals refer to like elements.

FIG. 1 schematically illustrates a structure of a related art plasma display panel;

FIG. 2 illustrates a method of manufacturing a related art plasma display panel;

FIG. 3 illustrates a method of manufacturing a plasma display panel according to a first embodiment of the present invention;

FIG. 4 illustrates a method of manufacturing a green sheet according to a second embodiment of the present invention;

FIG. 5 illustrates a method of forming an electrode pattern layer on the green sheet of FIG. 4;

FIG. 6 illustrates the green sheet according to the third embodiment of the present invention;

FIG. 7 illustrates the formation of a front panel by laminating the green sheet of FIG. 6 on a glass;

FIG. 8 illustrates a green sheet according to a fourth embodiment of the present invention;

FIG. 9 illustrates the formation of a front panel by laminating the green sheet of FIG. 8 on a glass;

FIG. 10 illustrates a green sheet according to a fifth embodiment of the present invention; and

FIG. 11 illustrates the formation of a front panel by laminating the green sheet of FIG. 10 on a glass.

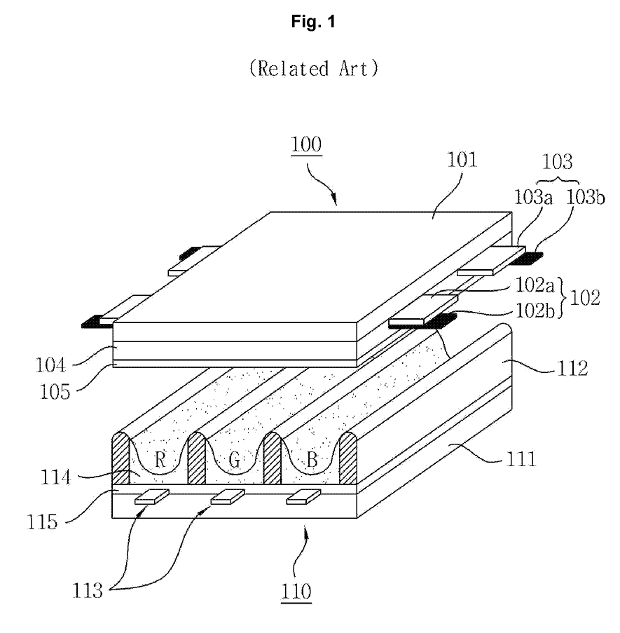

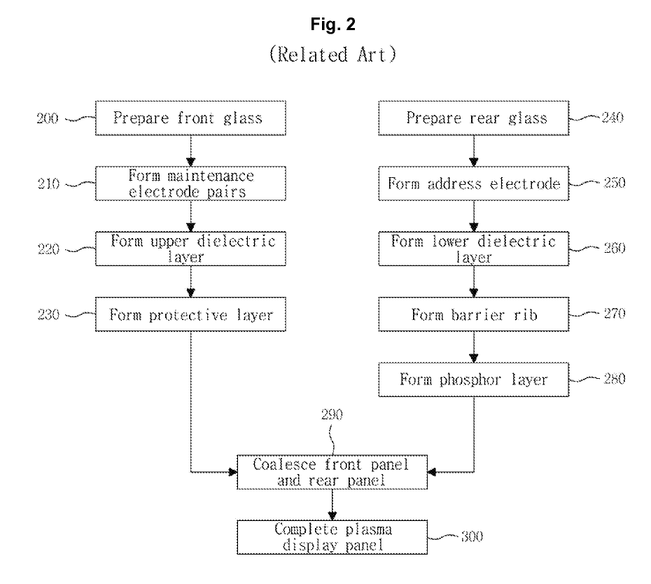

### DETAILED DESCRIPTION OF PREFERRED EMBODIMENTS

Preferred embodiments of the present invention will be described in a more detailed manner with reference to the drawings.

A method of manufacturing a plasma display panel according to embodiments of the present invention comprises laminating a green sheet comprising a dielectric layer and an electrode pattern on a substrate, and firing the substrate.

The laminating of the green sheet comprises forming the dielectric layer on a base film, forming a conductive layer on the dielectric layer, and patterning the conductive layer to form the electrode pattern.

In the forming of the electrode pattern, an electrode has a trapezoid-shaped section. A width of the electrode in a direction of the dielectric layer increases gradually toward an opposite direction of the direction of the dielectric layer.

The width of an electrode of the electrode pattern is equal to or less than 25% of the height of the electrode.

A plasma display panel according to the embodiments of the present invention comprises a substrate, a black layer formed on the substrate, an electrode formed on the black layer, and a dielectric layer formed on the electrode, the black layer and an upper surface of the substrate. There is a difference in elevation among the dielectric layer on the electrode, the dielectric layer on the black layer and the dielectric layer on the upper surface of the substrate.

A width of the electrode in a direction of the substrate is more than a width of the electrode in an opposite direction of the direction of the substrate.

The width of the electrode is equal to or less than 25% of the height of the electrode.

A green sheet according to the embodiments of the present invention comprises a dielectric layer, and a conductive layer formed on the dielectric layer.

The dielectric layer comprises an acrylic-based binder of a high molecular weight.

The conductive layer comprises a multi-functional monomer and an acrylic-based binder.

The conductive layer is an electrode pattern layer.

A method of manufacturing a green sheet according to the embodiments of the present invention comprises forming a dielectric layer on a base film, and forming a conductive layer on the dielectric layer.

The dielectric layer comprises coating a dielectric green sheet.

The forming of the conductive layer comprises printing an electrode pattern.

The forming of the conductive layer comprises coating a conductive green sheet.

The forming of the conductive layer comprises forming an electrode pattern on the conductive layer.

The forming of the electrode pattern comprises exposing the conductive layer in the range of 200 mJ/cm² to 400 mJ/cm².

The forming of the electrode pattern comprises developing the conductive layer in a developing solution containing Na₂CO₃ solution of 0.1% to 0.4% based on the total amount of the developing solution.

In the forming of the electrode pattern, an electrode has a rectangular-shaped section.

In the forming of the electrode pattern, an electrode has a trapezoid-shaped section. A width of the electrode in a direction of the dielectric layer gradually increases toward an opposite direction of the direction of the dielectric layer.

The width of an electrode of the electrode pattern is equal to or less than 25% of the height of the electrode.

Hereinafter, exemplary embodiments of the present invention will be described in detail with reference to the attached drawings.

FIG. 3 illustrates a method of manufacturing a plasma display panel according to a first embodiment of the present invention. As shown in FIG. 3, first, a front glass is prepared in step 410. A green sheet comprising a dielectric layer and an electrode pattern layer is prepared in step 420. The green sheet is laminated on the front glass in step 430. Subsequently, the front glass, on which the green sheet is laminated, is fired to form an electrode and the dielectric layer on the front glass in step 440. Here, the electrode of the electrode pattern layer has a trapezoid-shaped section. The width of the electrode in a direction of the dielectric layer gradually increases toward an opposite direction of the direction of the dielectric layer. The width of the electrode is equal to or less than 25% of the height of the electrode. As a result, there is a difference in elevation among the dielectric layer on the electrode, the dielectric layer on a black layer and the dielectric layer on the front glass.

The black layer is formed on the front glass of the plasma display panel thus manufactured and the electrode is formed on the black layer. The dielectric layer is formed on each of the electrode, the black layer and the front glass. Depending on a ratio of the width to the height of the electrode, there is no difference or a difference in elevation among the dielectric layers formed on the electrode, the black layer and the front glass. That is, when the width of the electrode is equal to or less than 25% of the height of the electrode, there is a difference in elevation among the dielectric layers formed on the electrode, the black layer and the front glass. The width of the electrode in a direction of the dielectric layer gradually increases toward an opposite direction of the direction of the dielectric layer.

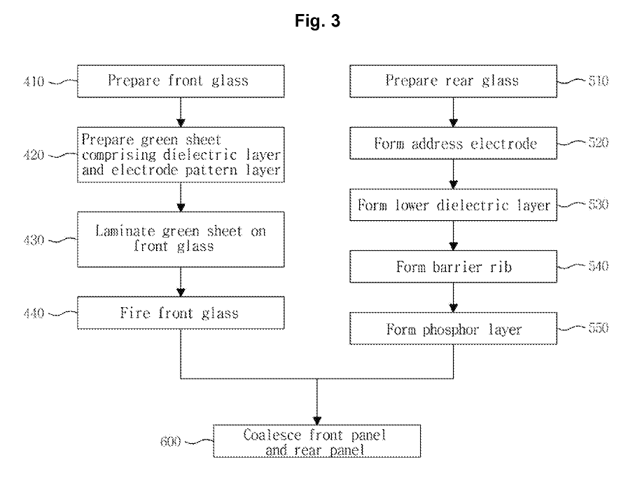

FIG. 4 illustrates a method of manufacturing a green sheet according to a second embodiment of the present invention. As shown in FIG. 4, a green sheet 810 according to the second embodiment of the present invention comprises a green sheet 710 including a conductive layer and a green sheet 750 including a dielectric layer.

In the green sheet 710, a conductive layer 730 is formed on a base film 720 and is covered with a cover film 740. The conductive layer 730 may comprise a photosensitive binder. For example, the conductive layer 730 may comprise a multi-functional monomer and an acrylic-based binder, and thus an under cut may be formed in the electrode formed by patterning the conductive layer 730.

Subsequently, in the green sheet 750, a dielectric layer 770 is formed on a base film 760 and is covered with a cover film 780. When developing the electrode by patterning the conductive layer 730, the dielectric layer 770 comprises an acrylic-based binder of a high molecular weight not to develop the dielectric layer 770.

The green sheet 810 according to the second embodiment of the present invention is formed by coating the green sheet 710 including the conductive layer 730 and the green sheet 750 including the dielectric layer 770. On other words, the green sheet 810 according to the second embodiment of the present invention is formed by coating the conductive layer 730 of the green sheet 710 on the dielectric layer 770 of the green sheet 750. Thus, in the green sheet 810 according to the second embodiment of the present invention, a dielectric layer 830 is formed on a base film 820 and a conductive layer 840 is formed on the dielectric layer 830. A cover film 850 is formed on the conductive layer 840.

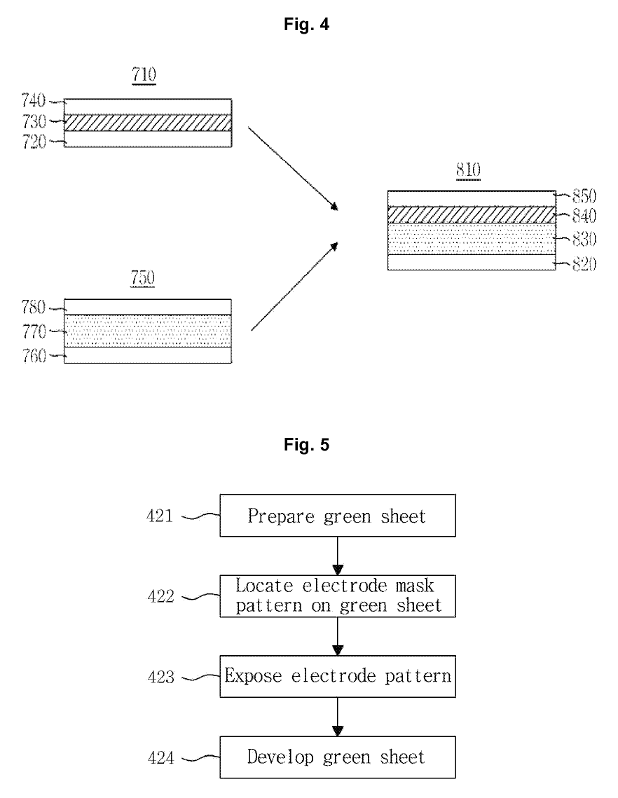

FIG. 5 illustrates a method of forming an electrode pattern layer on the green sheet of FIG. 4. First, a mask pattern of the electrode is located on the green sheet, and then the electrode pattern is exposed through an exposing device in steps 421 to 423. The electrode layer of the green sheet is exposed in the range of 200 mJ/cm² to 400 mJ/cm² (for example, 300 mJ/cm²). Subsequently, a developing process is performed on the green sheet through a developing device to form the electrode pattern layer in step 424. At this time, the green sheet is developed in a developing solution containing Na₂CO₃ solution ranging from 0.1% to 0.4% (for example, 0.3%) based on the total amount of the developing solution for 20 seconds.

Thus, the electrode pattern layer is formed on the conductive layer of the green sheet. However, since the dielectric layer of the green sheet comprises the acrylic-based binder of a high molecular weight, the dielectric layer is not developed by the developing process of the electrode layer.

In the second embodiment, the electrode pattern layer is formed by patterning the electrode layer on the green sheet. However, the electrode pattern layer may be formed by printing the electrode on the dielectric layer. In the above case, the green sheet of FIG. 4 comprises only the dielectric layer.

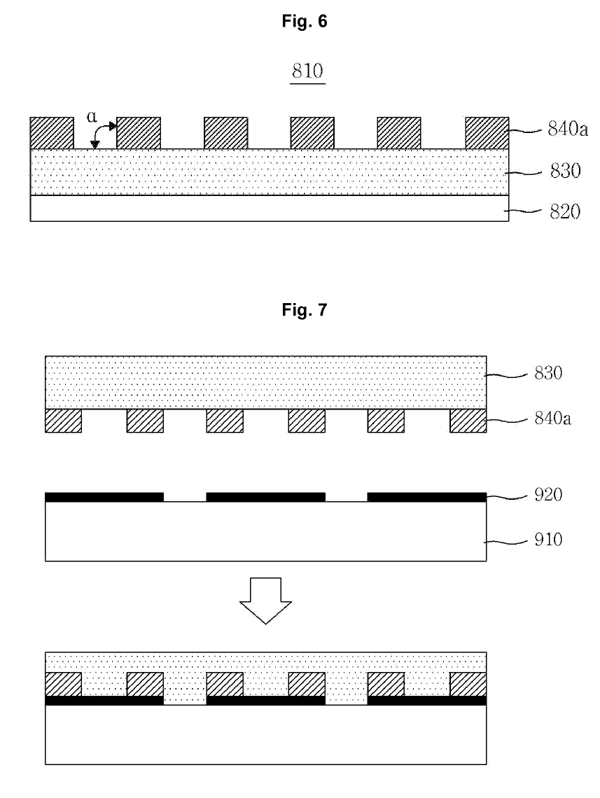

FIG. 6 illustrates the green sheet according to the third embodiment of the present invention. As shown in FIG. 6, the dielectric layer 830 is formed on the base film 820 of the green sheet 810 and an electrode pattern layer 840a is formed on the dielectric layer 830. A side of the electrode of the electrode pattern layer 840a makes nearly at a right angle (α=90°) with the dielectric layer 830. Thus, the conductive layer 840 of the green sheet 810 of FIG. 4 for forming the electrode pattern layer 840a of FIG. 6 may not comprise multi-functional monomer.

FIG. 7 illustrates the formation of a front panel by laminating the green sheet of FIG. 6 on a glass. As shown in FIG. 7, a black layer 920 is formed on a glass 910. The electrode pattern layer 840a is formed on the dielectric layer 830 of the green sheet 810.

The black layer 920 formed on the glass 910 and the electrode pattern layer 840a formed on the green sheet 810 are arranged. The green sheet 810 is laminated on the glass 910. Thus, the electrode and the dielectric layer are formed on the front glass.

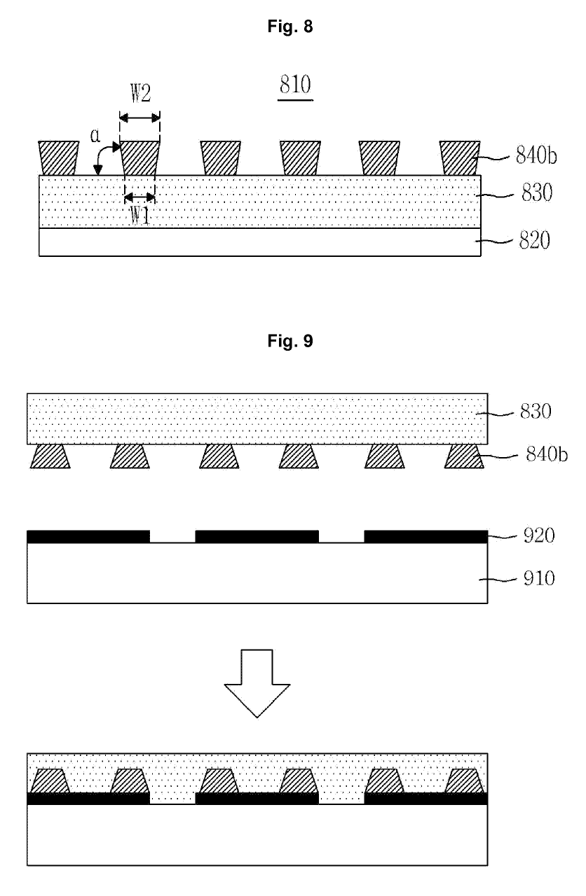

FIG. 8 illustrates a green sheet according to a fourth embodiment of the present invention. As shown in FIG. 8, a dielectric layer 830 is formed on a base film 820 of a green sheet 810 and an electrode pattern layer 840b is formed on the dielectric layer 830. A side of an electrode of the electrode pattern layer 840b makes at a predetermined angle α (0°<α<90°) with the dielectric layer 830. Therefore, in the electrode of the electrode pattern layer 840b, a width W1 of the electrode in a direction of the dielectric layer 830 is less than a width W2 of the electrode in an opposite direction of the direction of the dielectric layer 830. The electrode used in the fourth embodiment is referred to as a trapezoid-shaped electrode.

The conductive layer 840 of the green sheet of FIG. 4 for forming the electrode pattern layer of FIG. 8 comprises a multi-functional monomer.

FIG. 9 illustrates the formation of a front panel by laminating the green sheet of FIG. 8 on a glass. As shown in FIG. 9, a black layer 920 is formed on a glass 910. The electrode pattern layer 840b is formed on the dielectric layer 830 of the green sheet.

The black layer 920 formed on the glass 910 and the electrode pattern layer 840b formed on the green sheet are arranged. The green sheet is laminated on the glass 910. Thus, the electrode and the dielectric layer are formed on the front glass 910. When pressing the dielectric layer in a direction of the electrode pattern layer in the laminating process of the green sheet, the electrode is adhered closely to the dielectric layer in a direction for gradually increasing the width of the electrode. Therefore, no gap between the electrode and the dielectric layer occurs.

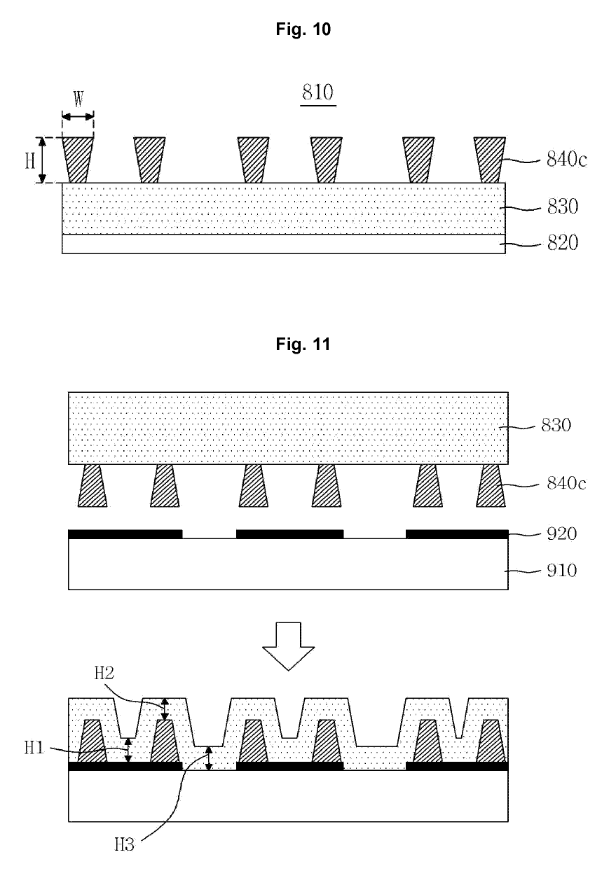

FIG. 10 illustrates a green sheet according to a fifth embodiment of the present invention. As shown in FIG. 10, a dielectric layer 830 is formed on a base film 820 of a green sheet 810 and an electrode pattern layer 840c is formed on the dielectric layer 830. A side of an electrode of the electrode pattern layer 840c makes at a predetermined angle α (0°<α<90°) with the dielectric layer 830. Therefore, in the electrode of the electrode pattern layer 840c, the width of the electrode in a direction of the dielectric layer 830 is less than the width of the electrode in an opposite direction of the direction. A width W of the electrode of the electrode pattern layer 840c is equal to or less than 25% of a height H of the electrode. The electrode used in the fifth embodiment is referred to as a trapezoid-shaped electrode.

The conductive layer 840 of the green sheet of FIG. 4 for forming the electrode pattern layer of FIG. 10 comprises a multi-functional monomer.

FIG. 11 illustrates the formation of a front panel by laminating the green sheet of FIG. 10 on a glass.

As shown in FIG. 11, a black layer 920 formed on a glass 910 and the electrode pattern layer 840c formed on the green sheet are arranged. The green sheet is laminated on the glass 910. Thus, the electrode and the dielectric layer are formed on the front glass 910. When pressing the dielectric layer in a direction of the electrode pattern layer in the laminating process of the green sheet, the electrode is adhered closely to the dielectric layer in a direction for gradually increasing the width of the electrode. Therefore, no gap between the electrode and the dielectric layer occurs. Further, there is a difference in elevation among the dielectric layers formed on the electrode, the black layer and the glass 910 by increasing the height of the electrode. In other words, a height H1 of the dielectric layer on the black layer 920, a height H2 of the dielectric layer on the electrode and a height H3 of the dielectric layer on the glass 910 are approximately equal to one another. Thus, a discharge voltage decreases and the efficiency of the plasma display panel is improved.

As described above, according to the embodiments of the present invention, since the bus electrode and the dielectric layer of the plasma display panel are formed by laminating the green sheet, the manufacturing process is simple and the manufacturing cost decreases. Further, since there is a difference in elevation among the dielectric layers on the bus electrode, the dielectric layer on the black layer and the dielectric layer on the front glass, a discharge voltage decreases and the efficiency of the plasma display panel is improved.

Moreover, since the green sheet comprising the dielectric layer and the conductive layer is provided, the electrode pattern layer may be formed on the conductive layer, if necessary.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of manufacturing a plasma display panel comprising:
laminating a green sheet comprising a dielectric layer and an electrode pattern on a substrate; and
firing the substrate.

2. The method of claim 1, wherein the laminating of the green sheet comprises forming the dielectric layer on a base film; forming a conductive layer on the dielectric layer; and patterning the conductive layer to form the electrode pattern.

3. The method of claim 2, wherein in the forming of the electrode pattern, an electrode has a trapezoid-shaped section, and a width of the electrode in a direction of the dielectric layer increases gradually toward an opposite direction of the direction of the dielectric layer.

4. The method of claim 2, wherein the width of an electrode of the electrode pattern is equal to or less than 25% of the height of the electrode.

5. A plasma display panel comprising:
a substrate;
a black layer formed on the substrate;
an electrode formed on the black layer; and
a dielectric layer formed on the electrode, the black layer and an upper surface of the substrate,
wherein there is a difference in elevation among the dielectric layer on the electrode, the dielectric layer on the black layer and the dielectric layer on the upper surface of the substrate.

6. The plasma display panel of claim 5, wherein a width of the electrode in a direction of the substrate is more than a width of the electrode in an opposite direction of the direction of the substrate.

7. The plasma display panel of claim 5, wherein the width of the electrode is equal to or less than 25% of the height of the electrode.

8. A green sheet comprising:
a dielectric layer; and
a conductive layer formed on the dielectric layer.

9. The green sheet of claim 8, wherein the dielectric layer comprises an acrylic-based binder of a high molecular weight.

10. The green sheet of claim 8, wherein the conductive layer comprises a multi-functional monomer and an acrylic-based binder.

11. The green sheet of claim 8, wherein the conductive layer is an electrode pattern layer.

12. A method of manufacturing a green sheet comprising:
forming a dielectric layer on a base film; and
forming a conductive layer on the dielectric layer.

13. The method of claim 12, wherein the forming of the dielectric layer comprises coating a dielectric green sheet.

14. The method of claim 12, wherein the forming of the conductive layer comprises printing an electrode pattern.

15. The method of claim 12, wherein the forming of the conductive layer comprises coating a conductive green sheet.

16. The method of claim 12, wherein the forming of the conductive layer comprises forming an electrode pattern on the conductive layer.

17. The method of claim 16, wherein the forming of the electrode pattern comprises exposing the conductive layer in the range of 200 mJ/ cm² to 400 mJ/cm².

18. The method of claim 16, wherein the forming of the electrode pattern comprises developing the conductive layer in a developing solution containing Na₂CO₃ solution of 0.1% to 0.4% based on the total amount of the developing solution.

19. The method of claim 16, wherein in the forming of the electrode pattern, an electrode has a rectangular-shaped section.

20. The method of claim 16, wherein in the forming of the electrode pattern, an electrode has a trapezoid-shaped section, and a width of the electrode in a direction of the dielectric layer gradually increases toward an opposite direction of the direction of the dielectric layer.

21. The method of claim 16, wherein the width of an electrode of the electrode pattern is equal to or less than 25% of the height of the electrode.
